(19) United States
(12) Patent Application Publication
(10) Pub. No.: US 2016/0320924 A1
(43) Pub. Date: Nov. 3, 2016

(54) Controller And Massage Machine

(71) Applicant: Fuji Medical Instruments Mfg. Co., Ltd., Osaka (JP)

(72) Inventors: Takashi Mizuguchi, Osaka-shi (JP); Kentaro Ode, Osaka-shi (JP)

(73) Assignee: Fuji Medical Instruments Mfg. Co., Ltd., Osaka (JP)

(21) Appl. No.: 15/009,758

(22) Filed: Jan. 28, 2016

(30) Foreign Application Priority Data
Apr. 28, 2015 (JP) 2015-091900

(51) Int. Cl. G06F 3/0482; A61H 9/00; A61H 15/00; G06F 3/0484; G06F 3/0488

(52) U.S. Cl. CPC G06F 3/0482; G06F 3/04842; G06F 3/04883; A61H 15/00; A61H 9/0078; A61H 2015/0042

(57) ABSTRACT

A chair type massage machine provided with treatment tools for treating prescribed locations of a human body, and also provided with a touch panel constituting a display device for displaying a treatment menu and other selection items and an operation device for selecting and operating the selection items, and a memory device for storing display information relating to selection items to be displayed on the touch panel; wherein at least a portion of the display information is standard display information relating to a standard mode for displaying a plurality of action selection items on the display means, and simple display information relating to a simple mode with fewer action selection items compared to the standard mode, and the chair type massage machine also has a mode switching processing unit for switching between the standard mode and the simple mode.

This application claims priority under 35 U.S.C. §119 to Japanese Patent Application Serial No. 2015-091900, filed Apr. 28, 2015, which is incorporated herein by reference in its entirety.

### FIELD OF THE INVENTION

The present invention pertains to a controller of a massage machine for massaging a human body and to a massage machine provided with the controller.

### BACKGROUND OF THE INVENTION

In recent years, chair type massage machines for performing various massages of a user's back area from the lower back to the neck and/or shoulder by complexly operating massage balls provided in the massage machine have been developed. In addition, massage machines and the like equipped with the massage balls as well as airbags for treatment using air pressure have also been developed, enabling users to receive massages of not only the back area but also multiple other areas such as the arms and/or legs either individually or simultaneously.

However, because the chair type massage machines and the like that have been developed in recent years are capable of massaging multiple areas of a human body and are designed with actions of treatment tools such as the massage ball and/or the airbags that can be set in a detailed manner, the controller for operating the chair type massage machine must be equipped with numerous operation buttons. As a result, the problem of a more complex configuration of the controller has arisen.

With regards to this type of problem, a massage machine controller that enables a user to identify and operate a plurality of operations buttons by forming the controller in a pattern which is modeled after the shape of a human body is disclosed.

More specifically, the controller described is formed in a pattern which is modeled after the shape of the user when the user's lower back is positioned in the chair type massage machine, and is provided at the top end with a projecting part which corresponds to the head area. By providing a controller having this type of configuration, a user to be treated can easily search for the positions of each operation button using the projecting part as a reference during use.

However, similar to conventional controllers, the controller described in patent document 1 is equipped with numerous operation buttons, and for example, a user who is unfamiliar with machines cannot understand which operation button to use. Furthermore, because of the numerous operation buttons, in some cases, the desired treatment is not received due to erroneous pressing of an operation button and/or to the pressing of an operation button for which the function is not understood.

As a result of these types of issues, problems have existed which include poor operability of the controller from the perspective of the user, and the inability to easily receive the desired treatment.

### SUMMARY OF THE INVENTION

One embodiment of the controller according to the present invention for operating the actions of a massage machine is provided with a treatment tool for treating a prescribed location of a human body, the controller includes a display means for displaying an action selection item of the massage machine; an operation means for selecting and operating the action selection item; and a display information memory unit for storing display information relating to the action selection item displayed by the display means; wherein at least a portion of the display information is: standard display information relating to a standard mode which displays a plurality of the action selection items in the display means; and simple display information relating to a simple mode which has fewer action selection items than those of the standard mode; and the controller further has a switching means for switching between the standard mode and the simple mode.

### BRIEF DESCRIPTION OF THE DRAWINGS

FIG. 1 is a schematic perspective view of a chair type massage machine.

FIG. 2 is an elevation view of a controller.

FIG. 3 is a block diagram of a chair type massage machine.

FIG. 4A through FIG. 4C are explanatory diagrams of a screen with regards to a setting method for simple mode.

FIG. 5 is flowchart of the setting method in simple mode.

FIG. 6 is an explanatory diagram of a mode selection screen for selecting standard mode and simple mode.

FIG. 7 is a flowchart until treatment startup in simple mode and standard mode.

FIG. 8A through FIG. 8C are explanatory diagrams of a display screen until treatment startup in standard mode.

FIG. 9A-FIG. 9B are explanatory diagrams of a display screen until treatment startup in simple mode.

FIG. 10A through FIG. 10D are explanatory diagrams of an arrangement method for arranging selection items on a display screen in simple mode.

FIG. 11A-FIG. 11B are explanatory diagrams of an arrangement method for arranging selection items displaying the usage history on a display screen in simple mode.

FIG. 12A-FIG. 12B are explanatory diagrams relating to the display of the usage history in simple mode.

FIG. 13A through FIG. 13C are explanatory diagrams of an arrangement method for arranging a treatment menu used at a high frequency in simple mode.

FIG. 14 is a flowchart of a method for displaying a treatment menu used at a high frequency on a simple mode display screen.

### DETAILED DESCRIPTION OF THE PREFERRED EMBODIMENTS

Embodiments for carrying out the present invention are described below with reference to the drawings.

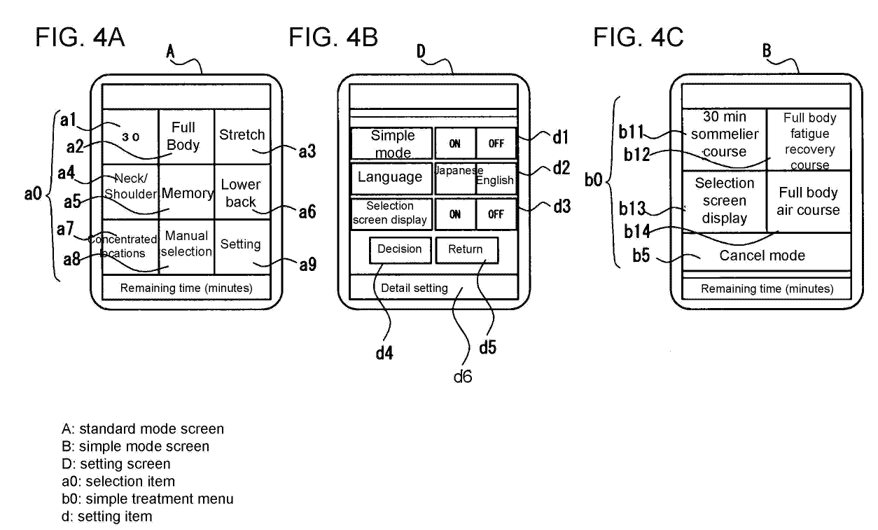

FIG. 4 is an explanatory diagram of a screen with regards to a setting method for simple mode, and more specifically, FIG. 4A shows a standard mode screen A, which is a display screen in standard mode, FIG. 4B shows a setting screen D, and FIG. 4C shows a simple mode screen B, which is a display screen in simple mode.

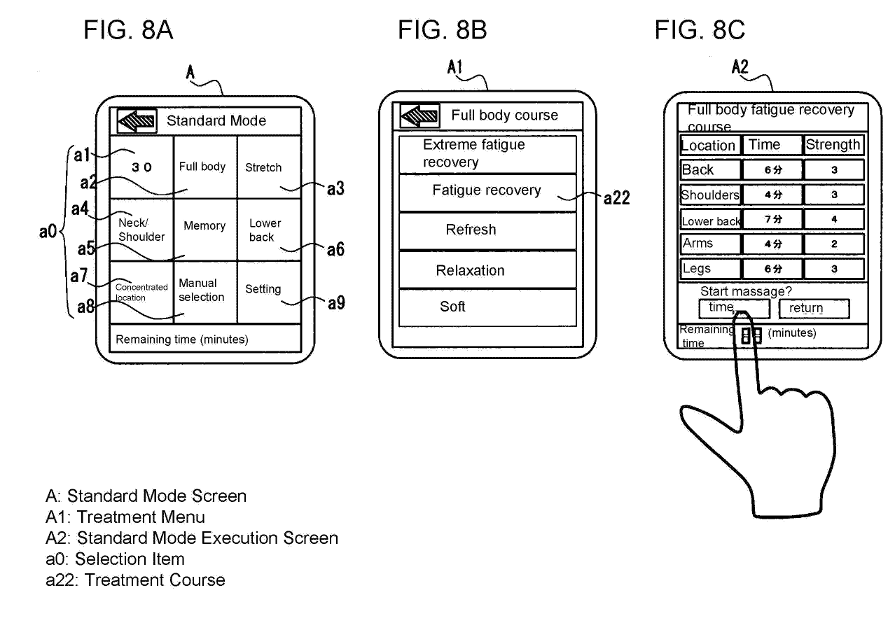

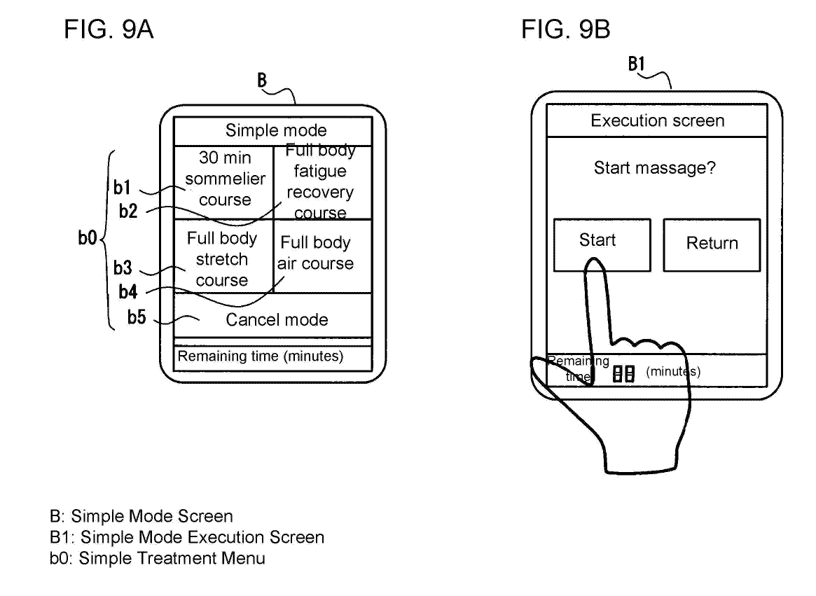

FIG. 8A through FIG. 8C are described next in greater detail. FIG. 8A shows the standard mode screen A, FIG. 8B shows a treatment menu display screen A1 for displaying a treatment menu, and FIG. 8C shows the details of a selected treatment menu and a standard mode execution screen A2 for execution. Moreover, explaining FIG. 9A and FIG. 9B in greater detail, FIG. 9A shows a simple mode screen B, and FIG. 9B shows a simple mode execution screen B1 for executing a selected treatment menu.

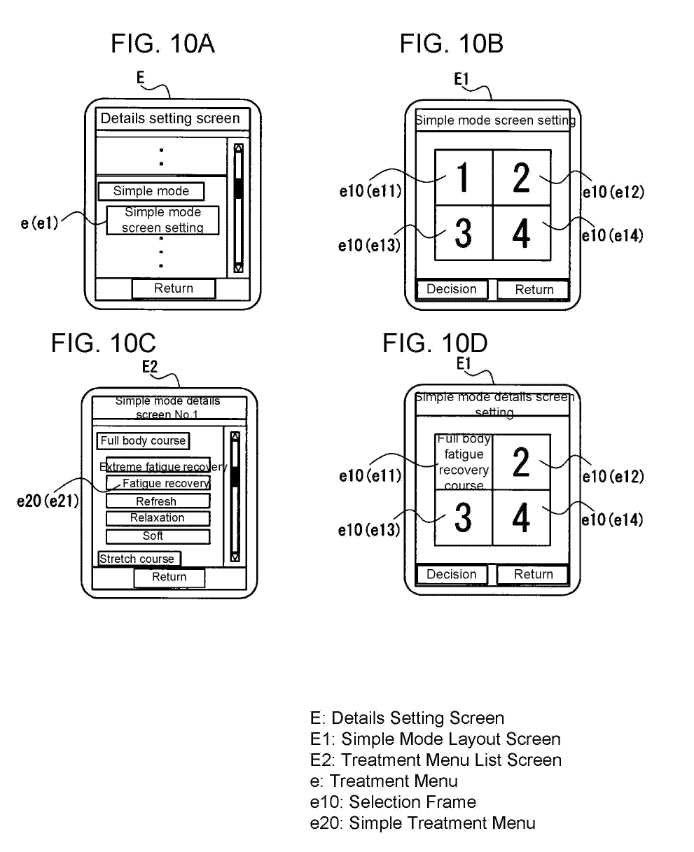

Describing FIG. 10A through FIG. 10D in greater detail, FIG. 10A shows a details setting screen E, which is a details setting screen for setting details of the screen and the like displayed on a touch panel 10, and FIG. 10B shows a simple mode screen setting E1 for setting selection items of the simple mode screen, FIG. 10C shows a treatment menu list screen E2 for displaying a treatment menu list, and FIG. 10D shows the simple mode screen setting E1 for which the selection item has been set.

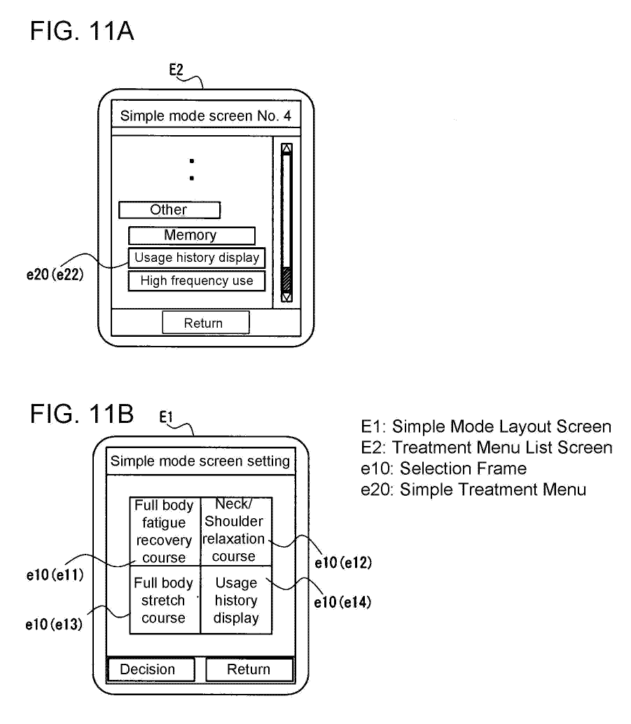

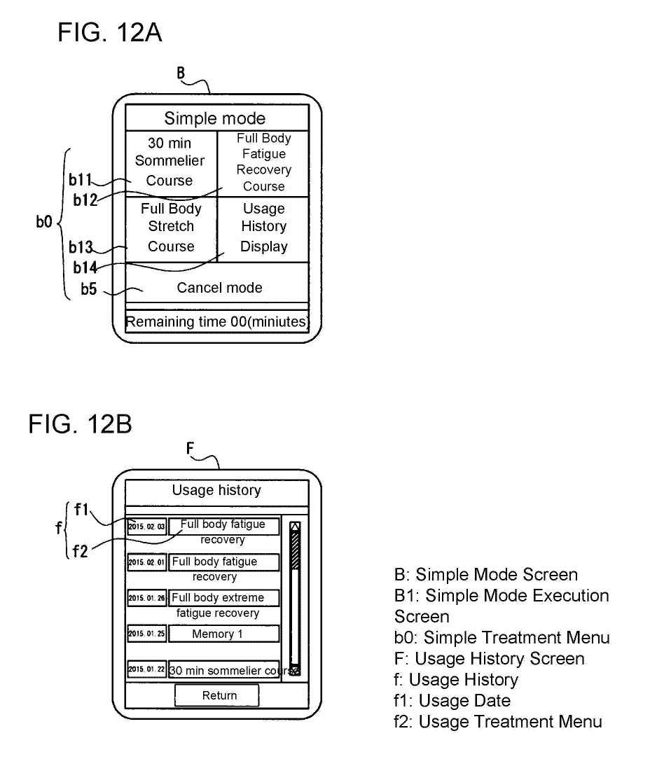

Describing FIG. 11A-FIG. 11B in greater detail, FIG. 11A shows the treatment menu list screen E2 displaying a treatment menu list, FIG. 11B shows the simple mode screen setting E1 for which the selection item has been set. Meanwhile, FIG. 12A shows the simple mode screen B, which is a display screen in simple mode, and FIG. 12B shows a usage history screen F.

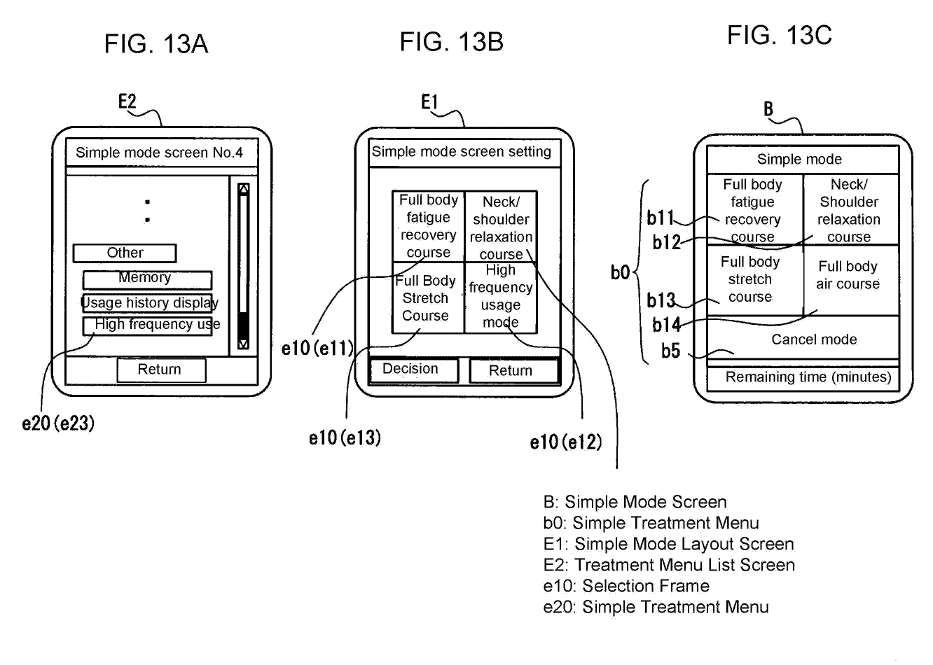

Describing FIG. 13A-FIG. 13B in greater details, FIG. 13A shows the treatment menu list screen E2 displaying a treatment menu list, FIG. 13B shows the simple mode screen setting E1 for which a selection item has been set, and FIG. 13C shows a simple mode screen B for a case in which a high frequency usage mode has been registered.

Note that in the present embodiment, as a general concept, a selection item is a selection menu selected by a user in order to execute a desired command in a controller 1 or a chair type massage machine 100 and is displayed on the touch panel 10, and includes a treatment course, which is content of a broadly classified treatment, and/or a treatment menu, which is a specific massage program with the treatment course being classified in greater detail, as well as items which change other setting details, and the like.

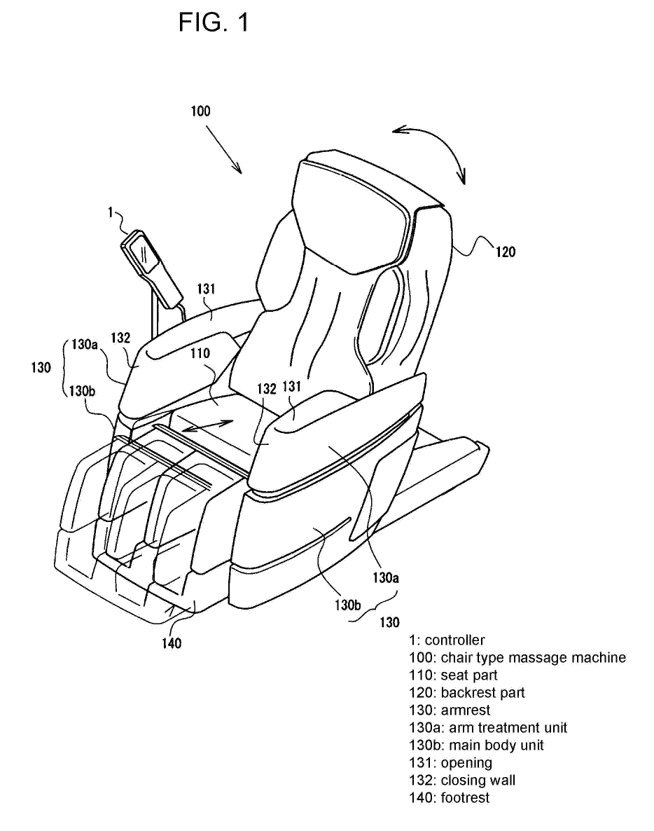

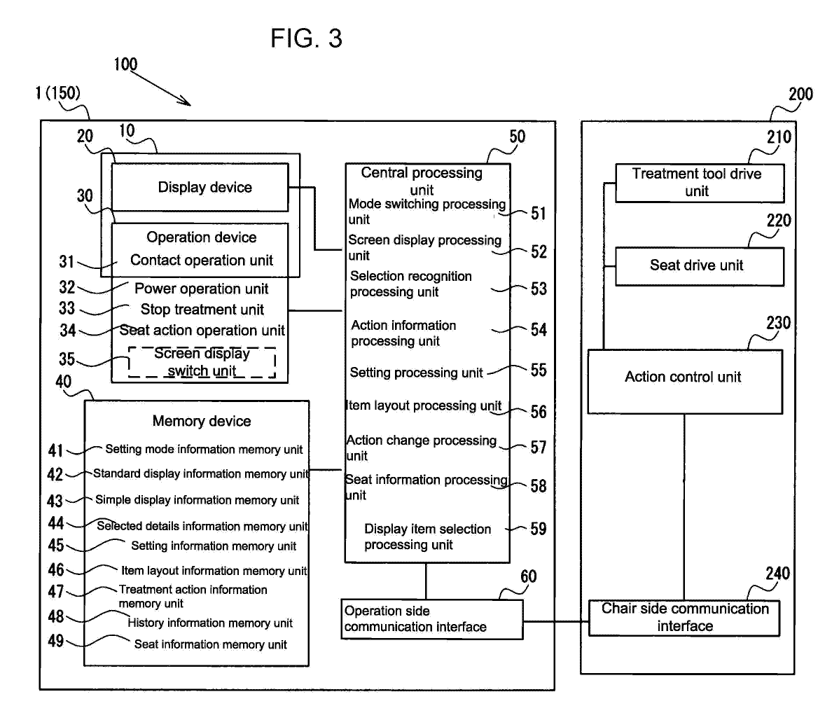

First, the configuration of the chair type massage machine 100 is described based on FIG. 1 and FIG. 3.

As shown in FIG. 1, the chair type massage machine 100 is provided with a seat part 110, a backrest part 120, armrests 130 provided at both the right and the left sides thereof, a footrest 140 pivotally supported at the front end of the seat part 110 and provided so as to be capable of rotating, and a controller 1 for controlling the actions of the chair type massage machine 100. Furthermore, the seat part 110 and backrest part 120, the armrests 130, and the footrest 140 respectively have appropriate treatment tools (not illustrated) such as massage balls and/or airbags.

The backrest part 120 of the chair type massage machine 100 is configured so as to be capable of reclining in the direction of the arrow shown in FIG. 1. Moreover, the backrest part 120 and the seat part 110 are coupled through a linking mechanism, and are thereby configured such that the reclining action of the backrest part 120 and the movement of the seat part 110 in the front and back directions are linked.

When the seat part 110 is moved forward, the footrest 140 pivotally supported at the front end of the seat part 110 is also linked and moves forward. Furthermore, an arm treatment unit 130a configuring the armrest 130 is coupled so as to be linked with the frontward and backward movement of the seat part 110, and as the seat part 110 moves forward, the arm treatment unit 130a moves to the rear.

The seat part 110 is a seat part against which the user positions his lower back, and as described above, is configured so as to be capable of moving forward and backward.

As shown in FIG. 1, in the initial state, the backrest part 120 is a backrest part that is upright in the roughly vertical direction at the rear of the seat part 110, and it supports the back area of a user seated in the seat part 110.

The armrest 130 is configured with the arm treatment unit 130a, formed with a width that is larger than the width of a human arm, and a main body unit 130b for supporting the arm treatment unit 130a at the lower end side.

As shown in FIG. 1, the arm treatment unit 130a has an opening 131 at the top surface. The opening 131 is established with a size which snuggly accommodates the arms (the entire front arm including the hands) and with a sufficient depth to allow the arms to be fully inserted. A closing wall 132 having a U-shape in a plan view is formed at the front end of the opening 131.

The footrest 140 is of a size that can snuggly accommodate the entirety of the lower leg and the feet of a human body, is coupled with the seat part 110 via a coupling part provided at the top, and is pivotally supported in the horizontal direction with respect to the seat part 110 so as to be capable of rotating about the coupling part.

Moreover, as shown in FIG. 3, the chair type massage machine 100 is provided internally with an action control mechanism 200 for electrically controlling the actions of the chair type massage machine 100. The action control mechanism 200 is provided with a treatment tool drive unit 210 for driving treatment tools such as massage balls and airbags provided with the chair type massage machine 100, a seat drive unit 220 for driving the seat part 110 and/or the backrest part 120 and the like, an action control unit 230 for controlling the driving of the treatment tool drive unit 210 and the seat drive unit 220, and a chair side communication interface 240 (also referred to as chair side communication I/F 240 below) for electrically connecting with the controller 1.

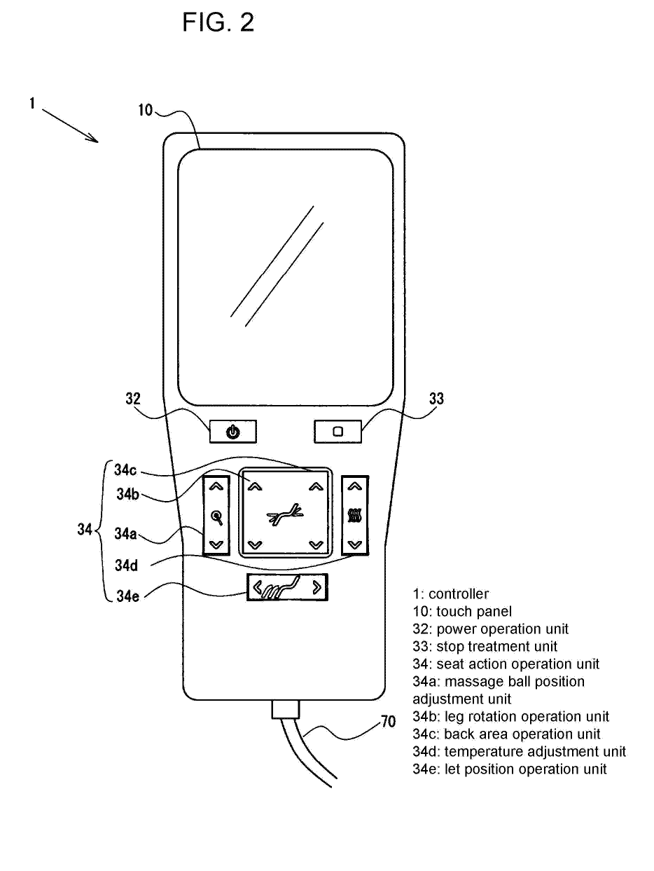

Next, the controller 1 provided with the chair type massage machine 100 is described based on FIG. 2 and FIG. 3.

As shown in FIG. 2, the controller 1 has a roughly rectangular shape with the vertical direction in a plan view as the longitudinal direction, and is a housing having a shape recessed in the internal direction at a roughly center portion.

The touch panel 10 capable of contact operations is provided at the front top, a switch type power operation unit 32, a switch type treatment stop treatment unit 33, and a seat action operation unit 34 are provided at a front center part.

Furthermore, a cable 70 for coupling the controller 1 and the chair type massage machine 100 is provided from the bottom part of the controller 1.

The controller 1 is also provided internally with an operation control mechanism 150 for electrically controlling the controller 1 and the chair type massage machine 100.

More specifically, the operation control mechanism 150 is configured with a display device 20, an operation device 30 for operating the controller 1 and the chair type massage machine 100, a memory device 40, a central processing device 50 for electrically controlling the controller 1, and an operation side communication interface 60 (referred to hereafter as “operation side communication I/F 60) for electrically connecting with the chair type massage machine 100.

The display device 20 is a constituent element of the touch panel 10, and for example, is a display device for transitioning and displaying, in hierarchical form, selection items including a treatment menu such as treatment courses, and/or a setting menu for environmental settings, and the like.

As shown in FIG. 3, the operation device 30 is configured with a contact operation unit 31 which configures the touch panel 10 together with the display device 20, the power operation unit 32 arranged to the left side of the front center of the controller 1, the stop treatment unit 33 arranged to the right side of the front center of the controller 1, and the seat action operation unit 34 arranged below the power operation unit 32 and the stop treatment unit 33 (see FIG. 2).

The contact operation unit 31 is a position detection system for recognizing the contact position when the surface of the display device 20 is contacted.

The power operation unit 32 is an operation unit for supplying power to a power path for the controller 1 and the chair type massage machine 100. In other words, the power operation unit 32 is a power button for starting up and shutting down the controller 1 and the chair type massage machine 100. The stop treatment unit 33 is a stop button for stopping all at once the actions of treatment tools provided with the chair type massage machine 100.

The seat action operation unit 34 is an operation unit for performing operations relating to the chair type massage machine 100 such as reclining, and the like, and it is configured of a massage ball position adjustment unit 34a, a leg rotation operation unit 34b, a back area operation unit 34c, a temperature adjustment unit 34d, and a leg position operation unit 34e.

The massage ball position adjustment unit 34a is a massage ball position adjustment button for adjusting the position of the massage ball, and as shown in FIG. 2, it has a roughly rectangular shape with the up-and-down direction being the longitudinal direction, and has a shape projected more in the vertical direction of the front face of the controller than the surface of the controller 1 (not illustrated). An operation of moving a massage ball provided in a backrest part 120 or the like in a direction along the backrest part 120 can be performed by pressing and holding the top part or bottom part of the massage ball position adjustment unit 34a having this type of configuration.

The leg rotation operation unit 34b and the back area operation unit 34c are integrally formed in roughly a square shape in a plan view at a center portion, and are a shape that is projected more in the vertical direction of the front face than the surface of the controller 1.

The leg rotation operation unit 34b provided at the front left side is an operation button for adjusting the position of the footrest 140 which rotates centered on a coupling part with the seat part 110, and the back area operation unit 34c provided at the front right side is an operation button for adjusting the reclining of the backrest part 120.

The temperature adjustment unit 34d provided at the right side of the back area operation unit 34c is a temperature adjustment button for adjusting the seat temperature of the seat part 110 and/or the backrest part 120 and the like, and as shown in FIG. 2, it has a roughly rectangular shape in a plan view. Furthermore, similar to the massage ball position adjustment unit 34a, the temperature of the seat part 110 and the like can be raised or lowered in stages by pressing and holding the top part or bottom part of the back area operation unit 34c.

The leg position operation unit 34e, provided below the leg rotation operation unit 34b and the back area operation unit 34c, has a rectangular shape with the longitudinal direction being the right and left direction in FIG. 2, and it is an operation button for adjusting the movement of the footrest 140 in the front and back directions. When the left side part of the leg position operation unit 34e is pressed and held, the footrest 140 moves forward, and when the right side part is pressed and held, the footrest 140 moves backward.

The memory device 40 is configured of an HDD and/or an SDD and the like, and is a memory device having the following functional configuration for storing various types of information. More specifically, the memory device 40 is configured with a setting mode information memory unit 41, standard display information memory unit 42, simple display information memory unit 43, selected details information memory unit 44, setting information memory unit 45, item layout information memory unit 46, treatment action information memory unit 47, history information memory unit 48, and a seat information memory unit 49.

The setting mode information memory unit 41 is a memory unit for storing mode setting information relating to which mode the controller 1 is set to, namely standard mode or simple mode. In other words, it is a memory unit that stores information on whether the display screen displayed on the touch panel 10 (display device 20) is a display screen based on standard mode or is a display screen based on simple mode.

The standard display information memory unit 42 is a memory unit for storing standard display information relating to the display screen displayed on the touch panel 10 (display device 20) in standard mode, and the simple display information memory unit 43 is a memory unit for storing simple display information relating to the display screen displayed on the display device 20 in simple mode.

The selected details information memory unit 44 is a memory unit for storing information relating to a detailed treatment menu displayed on the touch panel 10 (display device 20) when each treatment course is selected in standard mode, or in other words, it is a memory unit for storing a list of each treatment course and each treatment menu. The setting information memory unit 45 is a memory unit for storing setting information after a change has been made to a setting such as the environment of the controller 1 and/or the details setting selection menu displayed in the details setting screen E described below.

The item layout information memory unit 46 is a memory unit for storing layout information of selection items displayed on the touch panel 10 in simple mode, and the treatment action information memory unit 47 is a memory unit for respectively storing information on the actions of the chair type massage machine 100 based on each treatment course and treatment menu.

The history information memory unit 48 is a memory unit for storing usage history information such as the date a treatment menu was used and/or the usage frequency, and the like. Moreover, the seat information memory unit 49 is a memory unit for storing information on the movement of the seat and the like with respect to seat position information for the chair type massage machine 100 in the initial state.

The central processing device 50 is configured with a mode switching processing unit 51, a screen display processing unit 52, a selection recognition processing unit 53, an action information processing unit 54, a setting processing unit 55, an item layout processing unit 56, an action change processing unit 57, a seat information processing unit 58, and a display item selection processing unit 59.

The mode switching processing unit 51 is a processing unit for implementing switching processing between standard mode, which enables detailed settings so that a user can receive a desired treatment, and simple mode, which allows a user to easily receive a desired treatment.

The screen display processing unit 52 is a processing unit which reads information for various display screens to be displayed on the touch panel 10 from the memory device 40, and it implements display processing based on the display screen information. The selection recognition processing unit 53 is a processing unit which implements recognition processing of selection details based on position information detected by the contact operation unit 31.

The action information processing unit 54 is a processing unit which reads action information for the chair type massage machine 100 stored in the treatment action information memory unit 47 based on the treatment menu recognized by the selection recognition processing unit 53 when a treatment is executed, and transmits action information to the action control unit 230 provided with the chair type massage machine 100 via the below-described operation side communication FF 60.

The setting processing unit 55 is a processing unit for processing changes to setting information such as the brightness of the touch panel 10 and storing that information in the setting information memory unit 45, and the item layout processing unit 56 is a processing unit for processing changes to the layout position of each selection item in simple mode.

The action change processing unit 57 is a processing unit for processing changes to the details of actions of the chair type massage machine 100. In other words, the action change processing unit 57 is a processing unit for processing changes to the details of treatment action information stored in the treatment action information memory unit 47.

The seat information processing unit 58 is a processing unit for processing changes and the like to seat position information when, for example, the seat part 110 or the like is operated by pressing the seat action operation unit 34. The action control unit 230 controls the driving of the seat drive unit 220 based on information processed by the seat information processing unit 58, and moves the seat part 110 and/or reclines the backrest part 120, and the like.

The display item selection processing unit 59 is a processing unit which selects a treatment menu with a high usage frequency based on the usage frequency stored in the history information memory unit 48 when in the below-described high frequency usage mode, and also implements display processing for displaying the treatment menu in selection items to be displayed on the touch panel 10.

The operation side communication I/F 60 is an interface provided in the controller 1 to electrically connect with the chair side communication I/F 240 provided in the chair type massage machine 100. In the present embodiment, the controller 1 and the chair type massage machine 100 are connected through a cable 70.

Note that in the present embodiment, the controller 1 and the chair type massage machine 100 are connected by the cable 70, but a wired connection is not required, and a wireless connection using a WI-Fi (registered trademark) circuit and/or Bluetooth (registered trademark), or a wireless connection using RFID signals or the like may also be used.

The chair type massage machine 100 provided with this type of configuration is capable of switching between standard mode, which allows a user to select a more suitable treatment menu from amongst a selected treatment course and then receive the treatment, and simple mode, which allows a user to receive a desired treatment more easily than compared to standard mode; and in the case of standard mode, the standard mode screen A is displayed on the touch panel 10, while in the case of simple mode, the simple mode screen B is displayed on the touch panel 10.

Here, the screens of the abovementioned standard mode screen A and simple mode screen B are described based on FIG. 4A and FIG. 4C.

As shown in FIG. 4A, with the standard mode screen A, the main screen positioned in the center is divided into three equal parts in the vertical and horizontal directions, thereby forming a total of nine frames. In addition, respectively different selection items a0 (treatment course or selection items) are arranged in each frame.

More specifically, at the top row of the main screen of the standard mode screen A, a treatment course a1 which performs a 30 minute treatment (displayed as “30” in the figure; described hereinafter as only “30”, and the same applies to the other selection items), a treatment course a2 which performs a treatment on the entire body (“Full Body”), and a treatment course a3 which performs a body stretching treatment (“Stretch”) are aligned and arranged in order from the front left side. In the middle row, a treatment course a4 which performs a treatment centered on the neck and shoulders (“Neck/Shoulders”), a selection item a5 which saves a treatment menu in which treatment conditions have been set and saved by a user (“Memory”), and a treatment course a6 which performs a treatment with priority on the lower back (“Lower Back”) are aligned and arranged in order from the front left side.

On the bottom row, a treatment course a7 which performs a treatment with concentration on specific locations set by the user (“Concentrated Locations”), a treatment course a8 for which the treatment method is determined manually (“Manual Selection”), and a selection item a9 for setting the environment of the controller 1 (“Setting”) are arranged in order from the front left side.

Note that a separate frame is formed below the main screen of the standard mode screen A, and this separate frame is used for displaying the remaining treatment time and the like.

Next, the simple mode screen B is described based on FIG. 4C.

A 2×2 simple treatment menu b0 is arranged in the center of the simple mode screen B displayed on the touch panel 10. A simple treatment menu b11 (“30 min Sommelier Course”) is arranged in the left frame of the top row, and a simple treatment menu b12 (“Full Body Fatigue Recovery Course”) is arranged in the right frame of the top row. In addition, a simple treatment menu b13 (“Full Body Stretch Course”) is arranged in the left frame of the bottom row, and a simple treatment menu b14 (“Full Body Air Course”) is arranged in the right frame of the bottom row. Moreover, a simple mode selection item b5 for cancelling simple mode and switching to standard mode (“Cancel Mode”) is arranged below the bottom row.

Note that in order to prevent erroneous operation, the simple mode screen B may also be set so as to not display or so as to be incapable of selecting the simple mode selection item b5.

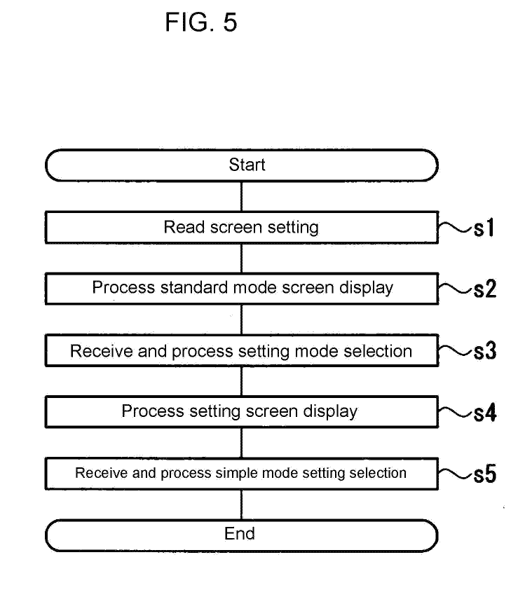

Next, the method for switching between standard mode and simple mode is described based on the flowchart shown in FIG. 5.

First, the controller 1 and the chair type massage machine 100 are started by pressing the power operation unit 32 provided on the controller 1. When this is done, the screen display processing unit 52 reads the mode setting information stored in the setting mode information memory unit 41 (step s1).

With the initial settings, the mode setting is set to standard mode, and therefore the screen display processing unit 52 reads the standard display information from the standard display information memory unit 42, and the standard mode screen A is displayed as the initial screen on the touch panel 10 (step s2).

When the standard mode screen A is displayed on the touch panel 10 (see FIG. 4A) and the selection item a9 (“Settings”) arranged at the right of the bottom row is touched with a finger, the selection recognition processing unit 53 recognizes that the selection item a9 (“Settings”) was selected (step s3), the setting information stored in the setting information memory unit 45 is read by the screen display processing unit 52, display processing is performed, and the setting screen D is displayed on the touch panel 10 (step s4).

As shown in FIG. 4B, with the setting screen D displayed on the touch panel 10, the setting items d are divided into three rows and provided in the center portion. “Simple Mode”, “Language”, and “Selection Screen Display” are displayed in order from the top, and to the right thereof in order from the top, the switch setting d1 for switching to simple mode (“ON”, “OFF”), the language setting d2 for setting the language (“Japanese”, “English”), and the selection display setting d3 for selecting standard mode or simple mode at the time of startup (“ON”, “OFF”) are arranged.

Note that the near the bottom of the setting screen D, a selection item d4 which displays “Decision” and is used to decide whether or not to accept changes made to the setting items, and a selection item d5 which displays “Return” and is used to not accept changes made to a setting are arranged in order from the left, and a separate frame is formed below that in which a detailed setting d6 for changing detailed settings (“Detailed Settings”) is arranged.

After “ON” of the switch setting d1 arranged to the right side of the item that displays “Simple Mode” of the setting screen D aligned as described above is touched and then the setting item d4 that displays “Decision” is touched, the selection recognition processing unit 53 recognizes that simple mode was set and selected, the setting processing unit 55 changes the details of the mode setting information stored in the setting mode information memory unit 41 and the details of the setting information stored in the setting information memory unit 45, and the mode setting information and setting information after the change are respectively stored in the setting mode information memory unit 41 and the setting information memory unit 45 (step s5).

Through this, the mode setting information is set to simple mode. Accordingly, the screen to be displayed on the touch panel 10 by the screen display processing unit 52 is subjected to processing to switch from standard mode to simple mode by the mode switching processing unit 51, and as a result, the simple mode screen B is displayed on the touch panel 10.

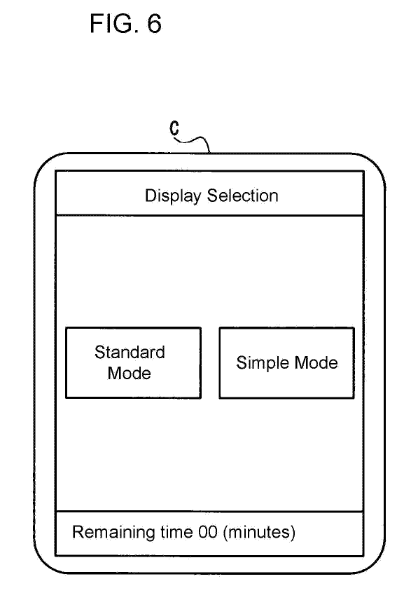

Note that by setting the selection display setting d3 (“Selection Screen Display) provided at the bottom row of the main screen of the setting screen D to “ON”, when the initial display screen is displayed, a mode selection screen C (see FIG. 6) that enables selection between standard mode and simple mode is displayed on the touch panel 10.

By providing the mode switching processing unit 51 for displaying simple mode on the display means and the screen display processing unit 52 at the time of startup in this manner, there is no need to switch the display screen displayed on the touch panel 10 from the standard mode screen A to the simple mode screen B each time the chair type massage machine 100 is used, and the chair type massage machine 100 can be started in simple mode at the time of startup. Accordingly, the procedures for launching simple mode when the chair type massage machine 100 is used can be reduced, and a user can comfortably use the chair type massage machine 100.

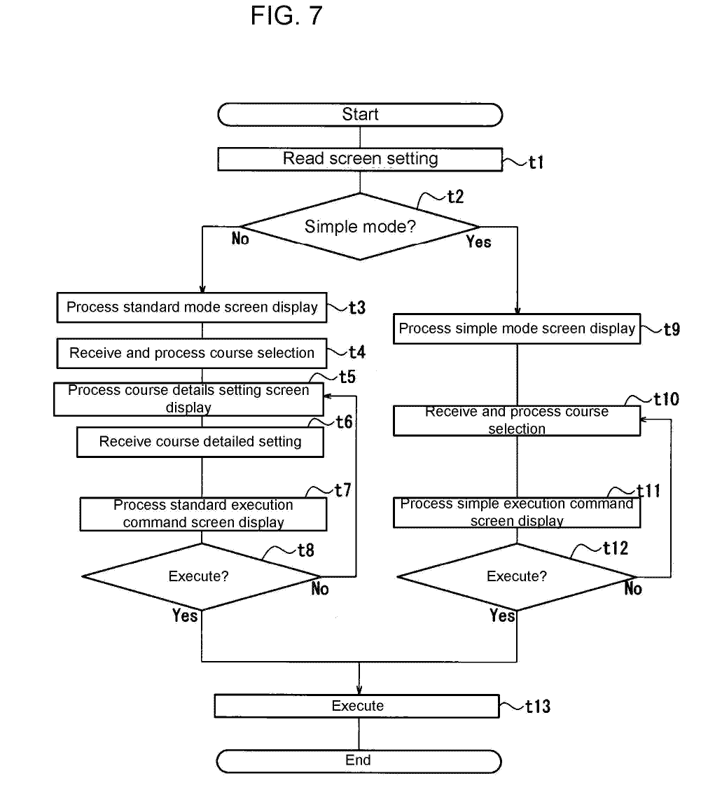

Next, the treatment methods of standard mode and simple mode using the controller 1 are described based on the flowchart shown in FIG. 7.

As described above, when the power operation unit 32 provided on the front of the controller 1 is pressed, the controller 1 and the chair type massage machine 100 are started, the mode setting information stored in the setting mode information memory unit 41 is read by the screen display processing unit 52 (step t1), and a determination is made as to whether or not the mode stored in the mode setting information is simple mode (step t2)

If the simple mode setting has not been performed, or in other words, if the mode is standard mode (step t2: No), the standard display information saved in the standard display information memory unit 42 is read by the screen display processing unit 52, and as shown in FIG. 8A, the standard mode screen A is displayed as the initial screen on the touch panel 10 (step t3).

Next, when the treatment course a2 (“Full Body”) is touched by a finger from among the selection items a of the standard mode screen A displayed on the touch panel 10, the selection recognition processing unit 53 recognizes that the treatment course a2 has been selected (step t4), the screen display processing unit 52 reads information relating to the treatment menu of each treatment course stored in the setting information memory unit 45, and the treatment menu display screen A1 shown in FIG. 8B is displayed on the touch panel 10 (step t5). Note that the treatment menu differs for each treatment course displayed in FIG. 8A.

When the user touches the desired treatment course a22 (“Fatigue Recovery”) from the treatment menu display screen A1 displayed on the touch panel 10, the selection recognition processing unit 53 recognizes that the treatment course a22 was touched (step t6), the screen display processing unit 52 reads treatment action information relating to the treatment course a22 from the treatment action information memory unit 47, and the standard mode execution screen A2 which displays the details (see FIG. 8C) is displayed on the touch panel 10 (step t7).

If the selected treatment is fine, the user touches the selection item displayed as “Start” at the bottom of the touch panel 10 with a finger (step t8: Yes), and executes the treatment (step t13).

If the user desires to change the treatment menu, he or she touches the selection item displaying “Return” (step t8: No), and thereby displays the treatment menu display screen A1, which is the full screen prior to the screen transition, on the touch panel 10 (step t5).

Note that when the user wishes to return the treatment menus display screen A1 displayed on the touch panel 10 to the standard mode screen A, the user may touch the arrow oriented to the left provided at the top left.

Meanwhile, if the display screen displayed on the touch panel 10 at the time of startup is not standard mode, but is simple mode (step t2: Yes), information to the effect that startup occurs with simple mode is included in the startup screen information stored in the setting mode information memory unit 41, and therefore in addition to the mode being switched from standard mode to simple mode by the mode switching processing unit 51, simple display information stored in the simple display information memory unit 43 is read by the screen display processing unit 52, and the simple mode screen B shown in FIG. 9A is displayed on the touch panel 10 (step t9).

Next, as shown in FIG. 9A, when the simple treatment menu b2 (“Full Body Fatigue Recovery Course”) displayed on the touch panel 10 is touched, the contact operation unit 31 detects the contact position information, the selection recognition processing unit 53 recognizes that the simple treatment menu b2 was selected (step t10), and the simple mode execution screen B1 shown in FIG. 9B is displayed on the touch panel 10 (step t11).

If the selected treatment course is fine, the user touches the selection item displaying “Start” on the touch panel 10 with a finger (step t11: Yes), and the treatment is started (step t12). If the selected treatment course is not desired, the user may touch the selection item displaying “Return” on the touch panel 10 (step 11: No), and can thereby return to the simple mode screen B shown in FIG. 9A.

In this manner, the controller 1 for operating the chair type massage machine 100 provided with treatment tools for treating a prescribed location of a human body is provided with the touch panel 10, configured with the display device 20 for displaying selection items such as treatment menu and an operation device 30 for selecting and operating the selection items, and a memory device 40 for storing display information relating to selection items displayed on the touch panel 10; at least a portion of the display information is: standard display information relating to the standard mode which displays a plurality of the action selection items in the display means, and simple display information relating to the simple mode which has fewer action selection items than those of the standard mode; and the controller further has the mode switching processing unit 51 for switching between standard mode and simple mode, and thereby operability is improved for the user, and the user can easily receive a desired treatment.

More specifically, the selection items displayed on the touch panel 10 in simple mode are fewer compared to the selection items displayed on the touch panel 10 in standard mode, and therefore by switching to simple mode, a user can suppress the display on the touch panel 10 of selection items not required for receiving a desired treatment, and the erroneous pressing of unnecessary selection items by a user and/or the pressing of selection items for which the function is not understood can be prevented.

In other words, by minimizing the selection items that are displayed, the possibility of erroneous operation by a user can be reduced, and therefore the controller 1 provides improved operability for the user, and the user can easily use the controller 1 to receive a desired treatment.

Moreover, to a user who desires to quickly and easily use the chair type massage machine 100 without implementing detailed action settings for the treatment tools, the display of a plurality of selection items is annoying, and can cause confusion with regards to which action selection item including the treatment menu to press when beginning use of the massage machine. However, by using the controller 1, the number of selection items (treatment menus) displayed on the touch panel 10 can be reduced, and therefore, the user can use the chair type massage machine 100 without feeling confused and/or annoyed by the operations.

Furthermore, a user who wishes to use multiple functions to receive a desired treatment can receive the desired treatment by switching to standard mode using the simple mode selection item b5 (“Cancel Mode”) provided with a function of the mode switching processing unit 51.

Moreover, by adopting the touch panel 10 capable of recognizing a selection item by a user touching a selection item displayed on the display device 20, the user can operate the controller 1 by directly touching a selection item displayed on the display means 20, and therefore the chair type massage machine 100 can be intuitively operated, operability can be further improved, and erroneous operations can be more reliably prevented.

Furthermore, by adopting a touch panel 10 for transitioning and displaying in hierarchical form as the display device 20 and adopting a configuration which reduces the frequency of the selection and operation of selection items in simple mode compared to that of selection and operation in standard mode, operability can be further improved, and treatments can be easily performed.

More specifically, by adopting the touch panel 10 for transitioning in hierarchical form as the display device 20, after a selection item has been selected and operated, the selected action item to be displayed on the touch panel 10 can be displayed as a new image. In other words, selected action items already displayed on the touch panel 10 can be set so as to be not displayed. Therefore, only the selection items necessary for the operation currently being performed are displayed on the touch panel 10, and the user can intuitively operate the machine without confusion.

Moreover, if a selection item is selected in this manner, the display screen displayed on the touch panel 10 transitions by the screen display processing unit 52, thereby decreasing the selection items, and because the operation frequency for use in simple mode (see FIG. 5) is lower compared to use in standard mode, the operations are simple to a user, and a treatment can be quickly received.

In addition to the abovementioned functions, the controller 1 can set a treatment menu other than a prescribed treatment menu such that it can be selected in simple mode. The method thereof is described below based on FIG. 10.

First, the selection item a9 (“Settings”) of the standard mode screen A displayed on the touch panel 10 in standard mode is selected (see FIG. 4A), and the setting screen D is displayed (see FIG. 4B). Next, the details setting d6 (“Detailed Settings”) provided at the bottom of the setting screen D is selected by touching the details setting d6, and then the setting processing unit 55 reads the details setting selection menu stored in the setting information memory unit 45, and the details setting screen E is displayed on the touch panel 10 (see FIG. 10A).

The details setting screen E displayed on the touch panel 10 has a main screen at the center of the touch panel 10, and a scroll is formed at the right side thereof. The details setting selection menu stored in the setting information memory unit 45 is displayed in the main screen, and the selection item displayed as “Return” for returning to the setting screen D is arranged in a separate frame screen provided at the bottom of the main screen.

The details setting selection menu includes, for example, selection items for changing the usage environment such as the brightness of the touch panel 10 and/or the size of the displayed text, and the like (not illustrated). Furthermore, a setting menu e for setting the usage environment for simple mode is provided in the details setting selection menu, and one of the setting menu e items is a simple screen setting menu e1 displayed as a “Simple Mode Screen Setting” (see FIG. 10A).

When the simple screen setting menu e1 (“Simple Mode Screen Setting”) is touched with a finger, the selection recognition processing unit 53 recognizes that the simple screen setting menu e1 (“Simple Mode Screen Setting”) was selected, information relating to a simple mode layout screen E1 stored in the item layout information memory unit 46 is read by the screen display processing unit 52, image display processing is implemented, and the simple mode layout screen E1 is displayed on the touch panel 10 (see FIG. 10B).

As shown in FIG. 10B, the simple mode layout screen E1 is formed with a separate frame screen provided below the main screen, which is provided in the center, four selection frames e10, namely selection frame e11 to selection frame e14, are formed in the main screen, and desired treatment menus can be arranged at the respective positions.

More specifically, when the selection frame e11 displayed in the simple mode layout screen E1 is touched by a finger, the selection recognition processing unit 53 recognizes that the selection frame e11 was selected, the treatment menu list information stored in the treatment action information memory unit 47 is read by the screen display processing unit 52, and the treatment menu list screen E2 for displaying the treatment menu list is displayed on the touch panel 10.

In addition to having a main screen in the center part, the treatment menu list screen E2 also has a scroll formed to the right side thereof. Furthermore, a selection item displaying “Return” for returning to the simple mode layout screen E1 is arranged in a separate frame screen provided below the main screen.

When a desired simple treatment menu e20 is selected from the displayed treatment menu list screen E2, a simple treatment menu e21 is registered in the selection frame e11 displayed in the simple mode layout screen E1.

More specifically, when a user touches a desired simple treatment menu e21 from the displayed treatment menu list screen E2 (here, the “Full Body Fatigue Recovery Course” is selected) with a finger, the selection recognition processing unit 53 recognizes that the simple treatment menu e21 was selected, and at the same time, the item layout processing unit 56 changes the details of the item layout information stored in the item layout information memory unit 46 to the details for registering the simple treatment menu e21 in the selection frame e11 displayed on the simple mode layout screen E1, and temporarily saves that change. Furthermore, the screen display processing unit 52 reads the item layout information saved in the item layout information memory unit 46 and performs image processing, and as a result, the simple mode layout screen E1 is displayed on the touch panel 10 with the desired simple treatment menu e21 displayed in the selection frame e11.

Through this, as shown in FIG. 10D, the “Full Body Fatigue Recovery Course” is displayed in the selection frame e11 displayed on the simple mode layout screen E1.

Likewise, similar operations are performed for the selection frames e12 to e14, the desired simple treatment menus are registered, and when the selection item (“Decision”) displayed in the separate frame e3 provided below the main screen is touched, layout information for the treatment menu displayed in the simple mode screen B is stored in the setting information memory unit 45, and when the simple mode screen B is launched, the desired treatment menu is displayed on the simple mode screen B.

Furthermore, a treatment menu set such that the treatment tool is set to perform a desired action can be registered on the simple mode screen B.

More specifically, when a selection item a5 displayed in the center of the standard mode screen A is selected, and the actions and/or time and the like (not illustrated) of each treatment tool are set on the touch panel 10, based on that setting, the action change processing unit 57 changes the treatment action information such that each treatment tool performs the desired actions, and the treatment action information thereof is stored in the treatment action information memory unit 47.

Therefore, a user can execute a treatment menu that has been personally set in simple mode by registering this action information stored in memory in the selection frame e14 or the like using the above-described method.

In this manner, by providing the item layout processing unit 56 for arranging selection items to be displayed on the touch panel 10 at desired positions in the simple mode screen B, and the item layout information memory unit 46 for storing layout information, which is information relating to the layout of selection items set by the item layout processing unit 56, for example, selection items which are not displayed on the simple mode screen B with the initial settings of simple mode can be replaced with selection items registered with the initial settings, and therefore desired selection items can be arranged on the simple mode screen B displayed on the touch panel 10 in simple mode, and a user can easily select and operate desired selection items.

Accordingly, a user can easily select and operate a desired treatment, and can receive the desired treatment.

Moreover, by providing the action change processing unit 57 for implementing settings such that the treatment tools perform desired actions, and the treatment action information memory unit 47 for storing information relating to preset actions set by the action change processing unit 57, and adopting at least a portion of the action selection items displayed by simple mode as preset action items that denote an action set by the action setting item, the preset action items set by the user such that the treatment tool performs a desired action can be displayed on the display unit in simple mode, and therefore the user can use simple mode to easily receive a desired treatment.

Furthermore, in addition to the treatment menu set with the initial settings, the simple treatment menu e displayed on the treatment menu list screen E2 also displays a “Usage History Display”, which displays the usage history of past use by a user, and/or a “High Frequency Use”, which automatically displays a treatment menu with a high usage frequency in the selection frame (see FIG. 11A), and these can be selected and displayed in the selection frame.

For example, as shown in FIG. 11B, by registering the simple treatment menu e22 (see FIG. 11A), which is displayed as the “Usage History Display” in the treatment menu list screen E2, in the selection frame e14, the “Usage History Display” can be displayed in the treatment menu b14 of the simple mode screen B displayed on the touch panel 10 (see FIG. 12A).

In this manner, when the “Usage History Display” displayed in the simple treatment menu b14 of the simple mode screen B is touched with a finger, the selection recognition processing unit 53 recognizes that the usage history display has been selected, and reads usage history information from the treatment action information memory unit 47, and then based on the usage history information, the screen display processing unit 52 displays a usage history screen F on the touch panel 10 (see FIG. 12B).

As shown in FIG. 12B, the usage history screen F displaying usage history information is configured of a main screen arranged in the center, a scroll formed to the right of the main screen, and a separate frame below the main screen, and a usage history f, which is a list of the usage history, is displayed in the main screen. A usage date f1 is displayed to the left of the usage history f, and a usage treatment menu f2 used in the past is displayed to the right.

Note that a selection item (“Return”) having a function of displaying the simple mode screen B is arranged in a separate frame.

With the usage history f displayed on the touch panel 10 in this manner, when the user touches the usage treatment menu f2 with a finger, the selection recognition processing unit 53 recognizes that the usage treatment menu f2 was selected, and the treatment execution screen B1 is displayed on the touch panel 10. Furthermore, the treatment menu can be executed by touching the selection item displaying “Start”.

By providing a history information memory unit 48 for storing history information relating to a treatment menu selected and operated in the past in this manner, and making at least a portion of the selection items (treatment menus) displayed by simple mode to be the simple treatment menu e22 (“Usage History Display”) for displaying history information, a user can know a treatment menu used in the past, can easily select a treatment menu that felt comfortable by the user from past usage history, and can receive a treatment based on that treatment menu.

Furthermore, for example, by registering “High Frequency Use” in the selection frame e14 to automatically display the treatment menu used with high frequency in the selection frame, the treatment menu with a high usage frequency can also be displayed in the simple treatment menu b4 of the simple mode screen B.

The registration method and display method thereof are described below.

Similar to the above-described method, the registration method includes touching the selection frame e14 of the simple mode layout screen E1 to display the treatment menu list screen E2 on the touch panel 10, and selecting a simple treatment menu e23 displayed as “High Frequency Use” and registering it in the selection frame e14 (see FIG. 13B). Furthermore, the selection item displaying “Decision” is then touched and recognized, and the item layout information is stored in the item layout information memory unit 46. Through this, the simple mode screen B displayed on the touch panel 10 is displayed based on the item layout information stored in the item layout information memory unit 46, and as shown in FIG. 13C, the treatment menu with a high usage frequency is displayed in the simple treatment menu b4.

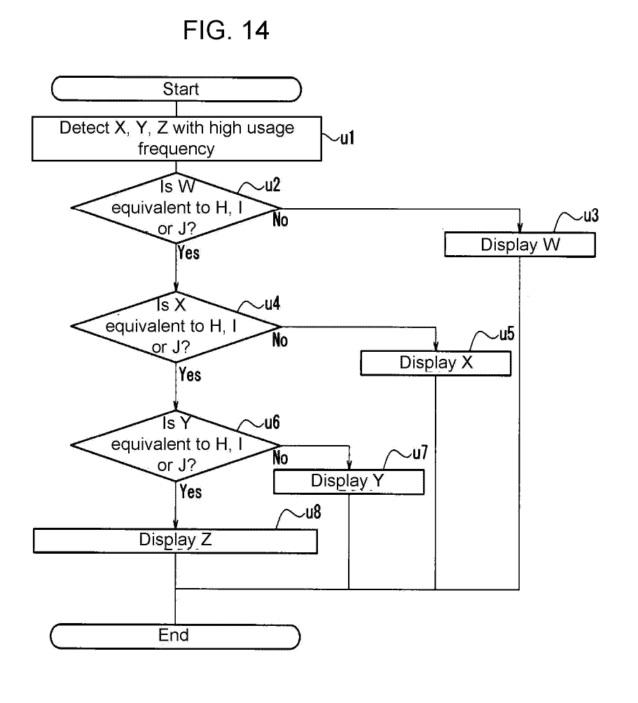

Next, the display method is described based on the flowchart of FIG. 14.

As a premise, the treatment menu registered in the selection frame e11 is a treatment menu H, the treatment menu registered in the selection frame e12 is a treatment menu I, the treatment menu registered in the selection frame e13 is a treatment menu J, and treatment menus with a high usage frequency are, from the top, treatment menus W, X, Y, and Z.

First, when the simple treatment menu e23 (“High Frequency Use”) is registered in the selection frame e14 through the above-described registration method, the display item selection processing unit 59 reads the usage history information for which the usage frequency has been saved from the history information memory unit 48, and of the treatment menus with a high usage frequency, the four with the highest usage frequencies are selected (step u1).

Next, the display item selection processing unit 59 determines if the treatment menu W with the highest usage frequency is the same as any of the treatment menus H, I, and J registered in the selection frames e11 to e13 (step u2), and if the treatment menu W is not the same as any of the treatment menus H, I, and J (step u2: No), the treatment menu W is displayed in the simple treatment menu b4 (step u3).

On the other hand, if the treatment menu W is the same as any of the treatment menus H, I, and J (step u2: Yes), the display item selection processing unit 59 determines if the treatment menu X with the second highest usage frequency is the same as any of the treatment menus H, I, and J (step u4).

Similar to the case of the treatment menu W, if the treatment menu X is not the same as any of the treatment menus H, I, and J (step u4: No), the treatment menu X is displayed in the simple treatment menu b4 (step u5).

On the other hand, if the treatment menu X is the same as any of the treatment menus H, I, and J (step u4: Yes), the display item selection processing unit 59 determines if the treatment menu Y with the third highest usage frequency is the same as any of the treatment menus H, I, and J (step u6).

Likewise, if the treatment menu Y is not the same as any of the treatment menus H, I, and J (step u6: No), the treatment menu Y is displayed in the simple treatment menu b4 (step u7), and if the treatment menu Y is the same as any of the treatment menus H, I, and J (step u6: Yes), the treatment menu Z with the fourth highest usage frequency is displayed in the simple treatment menu b4 (step u8).

An example is presented as shown in FIG. 13B for which the treatment menus H (“Full Body Fatigue Recovery Course”), I (“Neck/Shoulders Relaxation Course”), and J (“Full Body Stretch Course”) are respectively registered in the selection frame e11, selection frame e12, and selection frame e13, and the high usage frequency treatment menu W is the “Full Body Fatigue Recovery Course”, the treatment menu X is the “Neck/Shoulders Relaxation Course”, and the treatment menu Y is the “Full Body Air Course”.

In this case, the treatment menu W is the same as the treatment menu H (step u2: Yes), and the treatment menu X is the same as the treatment menu I (step u4: Yes). However, the treatment menu Y differs from the treatment menus H, I, and J (step u6: No), and the treatment menu Y (“Full Body Air Course”) is displayed in the simple treatment menu b4 of the simple mode screen B (see FIG. 13C).

In this manner, the controller 1 is provided with the history information memory unit 48 for storing the usage frequency of a prescribed treatment menu, and the display item selection processing unit 59 for selecting a treatment menu based on the usage frequency stored in the history information memory unit 48, and by making a portion of the selection items (treatment menus) displayed in simple mode the treatment menus selected by the display item selection processing unit 59, a treatment menu with a high usage frequency can be used as the treatment menu to be displayed on the simple mode screen B, and as a result, the treatment menu with a high usage frequency can be easily selected and implemented.

With regards to the correspondence between the configuration of the present invention and the above-described embodiment, the massage machine corresponds to the chair type massage machine 100;

the display means corresponds to the display device 20;

the operation means corresponds to the operation device 30;

the display information memory corresponds to the memory device 40;

the switching means corresponds to the mode switching processing unit 51;

the touch display means and the hierarchical display means correspond to the touch panel 10;

the screen display control unit corresponds to the mode switching processing unit 51 and the screen display processing unit 52;

the item arrangement unit corresponds to the item layout processing unit 56;

the layout information memory unit corresponds to the item layout memory unit 46;

the action setting unit corresponds to the action change processing unit 57;

the preset action memory unit corresponds to the treatment action memory unit 47;

the history information memory unit and the frequency memory unit correspond to the history information memory unit 48; and

the item selection unit corresponds to the display item selection processing unit 59; but

the present invention is not limited to only the configuration of the above-described embodiment, and numerous embodiments can be obtained.

For example, in the present embodiment, the controller 1 is used to operate the chair type massage machine 100, but in place of the controller 1, for example, a portable terminal like a smartphone or the like having a wireless connection function can be wirelessly connected with the chair type massage machine 100, and a program for controlling the actions of the chair type massage machine 100 can be downloaded such that the portable terminal can be used in place of the controller 1. Furthermore, the portable terminal and the chair type massage machine 100 may also be connected by wire through a USB or the like.

In addition, the mode switching processing unit 51 built into the controller 1 is used in the present invention to switch between standard mode and simple mode, but the present invention is not limited to this method, and for example, a screen display switch unit 35, which is a switching type switch may be provided on the outside (back side or the like) of the controller 1 (see FIG. 3), and the screen display switch unit 35 may be operated to switch between standard mode and simple.

Adopting this type of configuration not only simplifies the matter of switching to simple mode, but also eliminates the need for the user to operate selection items displayed on the touch panel 10 and reliably ensures that selection items with functions that are not understood are not displayed because there is no displaying of the standard mode screen A on the touch panel 10 due to erroneous operation of selection items displayed on the touchpad 10.

Accordingly, even a person unfamiliar with electronic devices can easily operate the chair type massage machine 100, and can easily receive a treatment.

Furthermore, in the present embodiment, the touch panel 10 having an integrated display device 20 and operation device 30 is used, but a touch panel does not necessarily have to be used, and for example, the display device 20 and the operation device 30 may be separate bodies, and a multifunction keypad and/or touch pad may be provided as the operation device 30.

The massage machine of the present invention is provided with the above-described controller, an action drive unit which drives the action of the treatment tool based on the action selection item selected and operated by the controller; and an action control unit which controls the actions of the treatment tool; and the treatment tool is at least one of an airbag or a massage ball.

The massage machine includes a chair type massage machine and/or a bed type massage machine, a massage machine specifically for feet, a massage machine for the buttocks, and the like. In other words, the massage machine may be any type of massage machine as long as it is a massage machine capable of relaxing a prescribed location of a human body.

The action selection item is an item in a menu of massage machine actions displayed on the display means, and for example, may include a course menu for performing prescribed treatments and/or a an action setting menu for setting detailed movements of the treatment tool such as the airbags and the massage balls.

The operation means is an operation means capable of selecting the action selection item displayed on the display means and performing the determined operation, and includes a contact type touch panel and/or a non-contact type touch panel provided in a manner integrated with the display means, and the display means includes multifunction keys and/or a touch pad provided as a separate unit.

Furthermore, the operations include touch operations, tap operations, drag operations, and flick operations performed by the fingertip or the like of the user contacting the contact type operation means, as well as combinations thereof

The switching means includes a menu for switching displayed on the display means and/or a switch type switching means provided on the main body of the controller.

The above-described switching and display includes, for example, a case in which the action selection items of the standard mode and the action selection items of the simple mode are switched and displayed on the display means, a case in which a selection display for selecting between the action selection items of standard mode and the action selection items of simple mode is displayed on the display means, and/or a case in which a setting for displaying one of either the action selection items of standard mode or the action selection items of simple mode is established in advance.

According to the present invention, operability for the user is improved, and the user can easily receive a desired treatment.

More specifically, there are fewer action selection items of simple mode compared to the action selection items of standard mode, and therefore by switching to simple mode, the user can prevent action selection items which are unnecessary for receiving the desired treatment from being displayed on the display means of the controller, and can prevent the erroneous pressing of unnecessary action selection items and/or the pressing of action selection items for which the function is not understood.

In other words, by reducing the number of action selection items that are to be displayed, the possibility of erroneous operation by the user can be reduced. Accordingly, operability from the perspective of the user can be improved, and the user can easily receive the desired treatment.

Moreover, to a user who desires to quickly and easily use the massage machine without having to implement detailed operation settings for the treatment tools, the display of a plurality of action selection items can be annoying and can cause confusion with regards to which action selection item to press when beginning use of the massage machine. However, with the present invention, the number of action selection items displayed on the display means can be reduced, and therefore, the user can use the massage machine without feeling confused and/or annoyed by the operations.

Furthermore, a user who desires to use multiple functions to receive a desired treatment can receive the desired treatment by switching to standard mode.

The display means for the present invention can be a touch display means for recognizing an action selection item by contact with the displayed action selection item.

The abovementioned contact includes contact by a portion of a human body and/or contact by a touch pen or the like. In other words, it includes all types of contact for recognizing the selection and operation of the action selection item displayed on the display means.

The touch display means is a display means provided with a position detection system for recognizing a contact position with respect to the touch display means through contact with the action selection item displayed on the touch display means, and indicates a so-called touch panel. Note that the position detection system includes a resistive film system, a surface elastic wave system, an electromagnetic induction system, an electrostatic capacitance system, and the like.

According to the present invention, the controller can be operated by directly contacting the action selection item displayed on the display means, and therefore the massage machine can be intuitively operated. Therefore, operability can be further improved, and erroneous operations can be more reliably prevented.

Also, as an aspect of the present invention, the display means may be a hierarchical display means for transitioning and displaying in a hierarchical form, and is configured to reduce the frequency of a selected operation of the action selection items in simple mode compared to when the action selection items are selected and operated in standard mode.

The abovementioned transitioning and displaying in a hierarchical form indicates the matter of displaying an entire display image to be displayed on the display means or a portion thereof as a new display image by operating the action selection item displayed on the display means using the operation means.

According to the present invention, operability can be further improved, and treatment can be easily performed.

More specifically, by adopting a hierarchical display means for transitioning to hierarchical form, after the action selection item is selected and operated, the selected action item displayed on the hierarchical display means can be displayed as a new image. In other words, the user can choose to not display the action selection item already displayed on the hierarchical display means. Therefore, only the selection items necessary for the operation currently being implemented are displayed on the hierarchical display means, the user can operate the massage machine without any confusion, and the massage machine can be operated intuitively.

Moreover, in spite of transitioning the display of the hierarchical display after the action selection item has been selected and operated, because the operation frequency of use in simple mode is lower than that of use in standard mode, the operations are simplified for the user, and the user can quickly receive a treatment.

Moreover, as an aspect of the present invention, the controller may further include a screen display control unit for displaying the simple mode in the display means at the time of startup.

According to the present invention, the massage machine can be started in simple mode each time the massage machine is used without having to switch from standard mode to simple mode. Through this, the user can quickly receive a desired treatment, and can pleasantly use the massage machine by omitting the procedures needed to start simple mode when using the massage machine.

As another aspect of the present invention, the controller may be provided with an item arrangement unit which arranges the action selection items displayed on the display means at a desired position of the display means; and a layout information memory unit for storing layout information relating to the arrangement of the action selection items established by the item arrangement unit.

The above-described matter of arranging at a desired position includes aligning and switching the action selection items to be displayed on a display unit with a desired order and/or arrangement, and/or displaying the desired action selection items in the display means, not displaying the unnecessary action selection items in the display means, and replacing the desired action selection items and the unnecessary action selection items.

According to the present invention, for example, the action selection items that are not displayed on the display means with the initial settings of simple mode can be replaced with other action selection items, and therefore the desired action selection items can be arranged in the display means in simple mode, and the user can easily select and operate the desired action selection items.

Accordingly, the user can easily select and operate a desired treatment, and can receive the treatment.

As another aspect of the present invention, the controller can be provided with an action setting unit which implements a setting such that the treatment tool performs a desired action; and a preset action memory unit for storing information relating to preset actions set by the action setting unit; wherein at least a portion of the action selection items displayed with the simple mode are preset action items that denote an action set by the action setting unit.

According to the present invention, preset action items, set such that the treatment tool performs an action desired by the user, can be displayed on the display unit in simple mode, and therefore the user can use simple mode to easily receive a desired treatment.

Moreover, as an aspect of the present invention, the controller can be provided with a history information memory unit for storing history information relating to the action selection items selected and operated in the past; wherein at least a portion of the action selection items displayed by the simple mode are history display items which display history information.

According to the present invention, the user can be informed of action selection items that have been used in the past, can easily select action selection items that felt comfortable by the user based on past usage history, and can receive treatment based on the action selection items.

As another aspect of the present invention, the controller can be provided with a frequency memory unit for storing an implementation frequency of a prescribed action selection item; and an item selection unit which selects the action selection item based on the implementation frequency stored in the frequency memory unit; wherein a portion of the action selection items displayed by the simple mode are selected action items which denote an action selected by the item selection unit.

According to the present invention, for example, the action selection items selected based on implementation frequency can be used as action selection items with a high implementation frequency, and can be displayed on the display means in simple mode. Accordingly, action selection items with a high implementation frequency can be easily selected and implemented.

What is claimed is:

1. A controller for operating the actions of a massage machine provided with a treatment tool for treating a prescribed location of a human body, the controller comprising:
a display means for displaying an action selection item of the massage machine;
an operation means for selecting and operating the action selection item; and
a display information memory unit for storing display information relating to the action selection item displayed by the display means; wherein
at least a portion of the display information is:
standard display information relating to a standard mode which displays a plurality of the action selection items in the display means; and
simple display information relating to a simple mode which has fewer action selection items than those of the standard mode;
and the controller further has a switching means for switching between the standard mode and the simple mode.

2. The controller according to claim 1, wherein the display means is a touch display means which recognizes the action selection item by touching the displayed action selection item.

3. The controller according to claim 1, wherein the display means is a hierarchical display means for transitioning and displaying in a hierarchical form, and is configured to reduce the frequency of a selected operation of the action selection items in the simple mode compared to when the action selection items are selected and operated in standard mode.

4. The controller according to claim 1, further comprising a screen display control unit which displays the simple mode in the display means at the time of starting.

5. The controller according to claim 1, further comprising:
an item arrangement unit which arranges the action selection items displayed in the display means at a desired position of the display means; and
a layout information memory unit for storing layout information relating to the arrangement of the action selection items established by the item arrangement unit.

6. The controller according to claim 1, further comprising:
an action setting unit which implements a setting such that the treatment tool performs a desired action; and
a preset action memory unit for storing information relating to preset actions set by the action setting unit; wherein
at least a portion of the action selection items displayed with the simple mode are preset action items that denote an action set by the action setting unit.

7. The controller according to claim 1, further comprising a history information memory unit for storing history information relating to the action selection items selected and operated in the past; wherein
at least a portion of the action selection items displayed by the simple mode are history display items which display history information.

8. The controller according to claim 1, further comprising:
a frequency memory unit for storing an implementation frequency of a prescribed action selection item; and
an item selection unit which selects the action selection item based on the implementation frequency stored in the frequency memory unit; wherein
a portion of the action selection items displayed by the simple mode are selected action items which denote an action selected by the item selection unit.

9. A massage machine comprising:
the controller according to claim 1;
an action drive unit which drives the action of the treatment tool based on the action selection item selected and operated by the controller; and
an action control unit which controls the actions of the treatment tool;
and the treatment tool is at least one of an airbag or a massage ball.
